(19) United States
(12) Patent Application Publication
(10) Pub. No.: US 2013/0183951 A1
(43) Pub. Date: Jul. 18, 2013

(54) DYNAMIC MOBILE APPLICATION CLASSIFICATION

(71) Applicant: Shih-Wei Chien, Hsinchu City (TW)

(72) Inventor: Shih-Wei Chien, Hsinchu City (TW)

(21) Appl. No.: 13/348,654

(22) Filed: Jan. 12, 2012

(51) Int. Cl. H04W 24/00

(52) U.S. Cl. 455/418

(57) ABSTRACT

In accordance with embodiments of the present disclosure, a process for classifying a mobile application is provided. The process may detect, by an application classification module, a mobile application located on a mobile device. The process may further extract, by the application classification module, a set of embedded data from the mobile application; and obtain a classification for the mobile application by analyzing the set of embedded data using a pattern and training set database.

### BACKGROUND

Unless otherwise indicated herein, the approaches described in this section are not prior art to the claims in this application and are not admitted to be prior art by inclusion in this section.

As downloading and installing a mobile application on a mobile device by anyone having access to the Internet and also the mobile device becomes increasingly simple, it also becomes increasingly difficult to determine whether the downloaded and installed mobile application is appropriate for the user of the mobile device beforehand. For example, some mobile applications may contain pornographic, violent, and other unsuitable materials for minors.

Similarly, due to the mass number of mobile applications becoming available on the Internet, the operators of application stores, who offer the mobile applications to mobile device users, have trouble knowing in advance the contents and the behavior of each of the offered mobile applications. There also lacks a reliable or an efficient technique for the operators to classify the mobile applications.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 is a block diagram illustrating an operational environment in which one or more classification systems may be implemented to classify mobile applications;

FIG. 2 illustrates scenarios of classifying a mobile application on a mobile device;

FIG. 3A-3B illustrate multiple scenarios of dynamically extracting data from a mobile application on a mobile device;

FIG. 4 illustrates a flow diagram of an example process for classifying a mobile application running on a mobile device

FIG. 5 illustrates a flow diagram of an example process for dynamically extracting embedded data from a running mobile application; and

FIG. 6 illustrates a flow diagram of an example process for adaptively adjusting a general classification for a mobile application based on a specific classification, all arranged in accordance with at least some embodiments of the present disclosure.

### SUMMARY

In accordance with one embodiment of the present disclosure, a method for classifying a mobile application include detecting, by an application classification module, a mobile application located on a mobile device. The method may further include extracting, by the application classification module, a set of embedded data from the mobile application, and obtaining, by the application classification module, a classification for the mobile application by analyzing the set of embedded data using a pattern and training set database.

In accordance with another embodiment of the present disclosure, a method for classifying a mobile application running on a mobile device may include obtaining, by a classification collection module, a first classification for the mobile application and a set of embedded data extracted from the mobile application. The method may further include processing, by the classification collection module, the set of embedded data to extract a set of patterns and features; and storing, by the classification collection module, the set of patterns and features to a pattern and training set database, wherein the pattern and training set database is used by an application classification module to classify the mobile application.

In accordance with a further embodiment of the present disclosure, a system configured to classify a mobile application running on a mobile device may include a data extractor for monitoring the mobile application and extracting a set of embedded data from the mobile application. The system may further include a classifier coupled with the data extractor for receiving the set of embedded data from the data extractor, and generating a classification for the mobile application based on the set of embedded data.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, computer programs, and systems related to statically and dynamically classifying of mobile applications. Throughout the disclosure, the term “classification” may broadly refer to a rating or a certification of the suitability of a mobile application for different audiences in terms of sexuality, violence, substance abuse, profanity, impudence, and other types of mature contents. In other words, the classification for a mobile application running on a mobile device may allow a user to pre-determine whether such mobile application is suitable for himself or minors that may have access to the mobile device, before executing the mobile application. In some embodiments, the classification may resemble a rating system for movies or TV programs. For example, the classification may have a value that is selected from a list containing “General Public”, “Parent Advised”, “Restricted”, and “NC-17”, in an order from the least severe to the most severe.

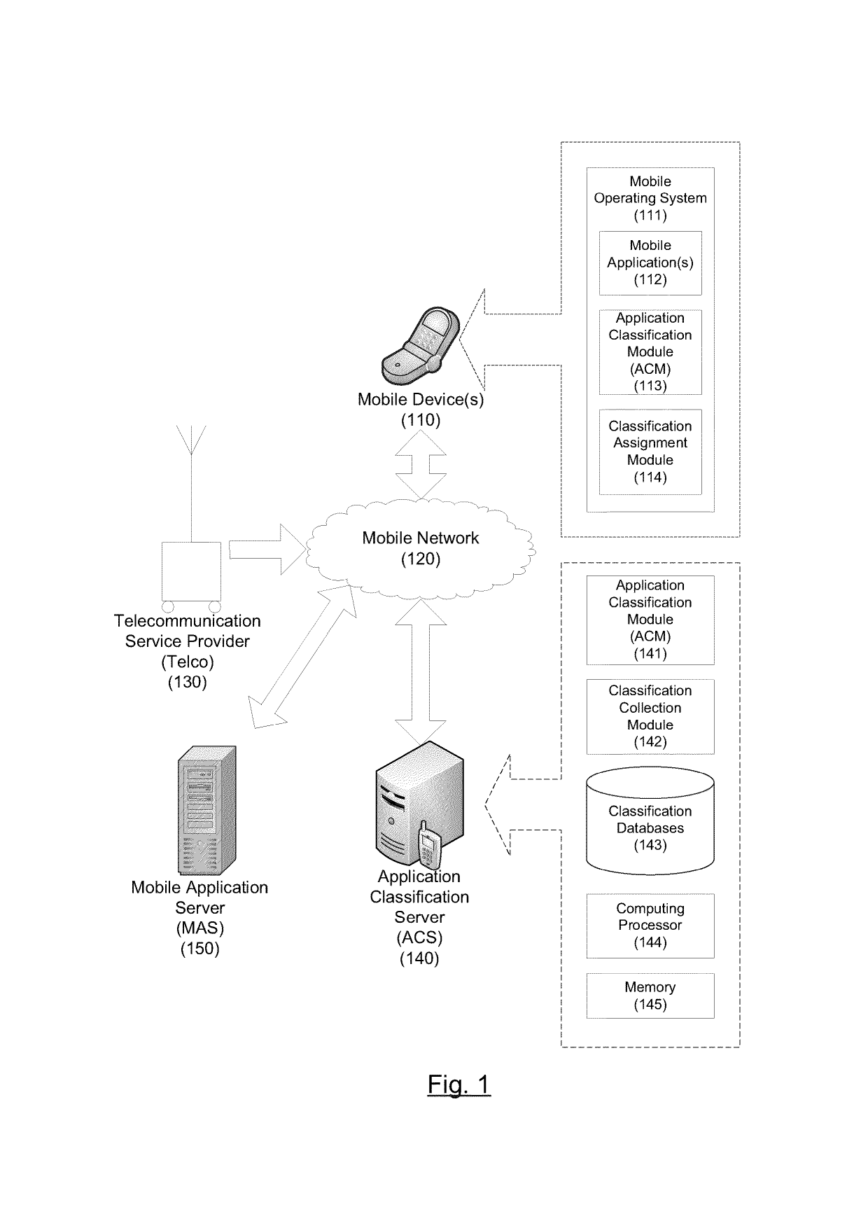

FIG. 1 is a block diagram illustrating an operational environment in which one or more classification systems may be implemented to classify mobile applications, in accordance with at least some embodiments of the present disclosure. In FIG. 1, a mobile device 110 may be configured to communicate with a mobile application server 150 via a mobile network 120. The mobile network 120 may be provided and managed by a telecommunication (Telco) service provider 130. An application classification server 140 may be connected with the mobile network 120 to provide classification related services to the mobile application server 150 and the mobile device 110.

In some embodiments, the mobile device 110 may be configured as a computing device that is capable of communicating with other applications and/or devices in a network environment. The mobile device 110 may be a mobile, handheld, and/or portable computing device, such as, without limitation, a Personal Digital Assistant (PDA), cell phone, and smart-phone. The mobile device 110 may support various mobile telecommunication standards such as, without limitation, Global System for Mobile communication (GSM), Code Division Multiple Access (CDMA), and Time Division Multiple Access (TDMA), as well as 3G standards. The mobile device 110 may also be a tablet computer, a laptop computer, and a netbook that is configured to support wired or wireless communication. For example, the mobile device 110 may be a tablet computer configured with a 3G communication adapter, which takes advantage of 3G mobile telecommunication services provided by the Telco service provider 130.

In some embodiments, the mobile device 110 may contain, among other things, multiple hardware or software components, such as a mobile operating system 111, one or more mobile applications 112, an application classification module 113 (ACM 113), and/or a classification assignment module 114. The mobile operating system 111 (mobile OS 111) may be responsible for providing functions to, and supporting communication standards for, the mobile device 110. Examples of the mobile OS 111 include, without limitation, Symbian®, RIM Blackberry®, Apple iOS®, Windows Mobile®, and Google Android®. The mobile OS 111 also provides the one or more mobile applications 112 and the ACM 113 a common programming platform, irrespective of the numerous hardware components that the mobile device 110 may be based on.

In some embodiments, the mobile device 110 may also contain one or more mobile applications 112. The mobile application 112 may utilize the software and hardware capabilities of the mobile device 110 to perform network functions (e.g., telephony, email, text-messaging, and/or web-browsing) and/or non-network functions (e.g., audio/video playback, multi-media capturing and editing, and gaming). During operation, the mobile application 112 may access internal or external storages, as well as communicate with the mobile application servers 150 via the mobile network 120.

In some embodiments, the mobile network 120 may be a wired network, such as, without limitation, local area network (LAN), wide area network (WAN), metropolitan area network (MAN), global area network such as the Internet, a Fibre Channel fabric, or any combination of such interconnects. The mobile network 120 may also be a wireless network, such as, without limitation, mobile device network (GSM, CDMA, TDMA, and others), wireless local area network (WLAN), and wireless Metropolitan area network (WMAN). Network communications, such as HTTP requests/responses, Wireless Application Protocol (WAP) messages, Mobile Terminated (MT) Short Message Service (SMS) messages, Mobile Originated (MO) SMS messages, or any type of network messages may be supported among the devices connected to the mobile network 120.

In some embodiments, the Telco provider 130 may provide telecommunication services such as telephony and data communications in a geographical area and serve as a common carrier, wireless carrier, ISP, and other network operators at the same time. In one implementation, the mobile device 110, the mobile application server 150, and the application classification server 140 may all subscribe to the services provided by the Telco service provider 130, enabling them to communicate among one another via the mobile network 120.

In some embodiments, the mobile application server 150 (“MAS 150”) may be directly connected to the mobile network 120 or indirectly accessed through the mobile network 120 via the Telco service provider 130. The MAS 150 may provide telephony, email, text-messaging and/or other network services to a specific type of mobile applications 112. It may also act as a streaming server to provide real-time audio/video streaming service to one or more mobile devices 110. In some embodiments, the MAS 150 may provide an application store similar to Apple® “App Store” or Andriod® “Market”, which allow the mobile device 110 to browse and select a mobile application 112 for installation. The selected mobile application 112 may then be downloaded from the application store. Alternatively, the mobile device 110 may download a mobile application 112 from any other sources similar to the MAS 150.

In some embodiments, a mobile application provider may upload its mobile application 112 to the MAS 150 for user download and usage. The application classification server 140 (“ACS 140”) may utilize its capabilities to classify the mobile application 112 before making it available for public access. The ACS 140 may contain, among other things, an application classification module 141 (“ACM 141”, which is similar to the ACM 113), a classification collection module 142, one or more classification databases 143, one or more computing processors 144, and a memory 145.

In some embodiments, the ACM 141 may be configured to classify the mobile application 112 stored in the MAS 150, and the ACM 113 may be configured to classify the mobile application 112 that has been downloaded, installed, and/or is executing on the mobile device 110. For example, before installing the downloaded mobile application 112 on the mobile device 110, the ACM 113 may try to evaluate the mobile application 112 and generate a classification. Upon a determination that the classification is below a certain standard, the ACM 113 may either preventing the mobile application 112 from being installed, or preventing the mobile application 112 from executing, on the mobile device 110. The ACM 113 may be configured to perform additional functions such as determining the type of the mobile application 112 installed or running on the mobile device 110, detecting the initialization and execution of the mobile application 112, and/or monitoring the network usage patterns of the mobile application 112.

Likewise, the ACM 141 may perform similar classification functions as the ACM 113. For example, before allowing a mobile application 112 being available to the general public, the ACM 141 may first determine a classification for the mobile application 112. If the classification is below a certain standard, the ACM 141, as well as the ACS 140 and the MAS 150, may prevent the mobile applications 112 from being accessed from the mobile network 120. During a classification process, the ACM 113 and the ACM 141 may utilize the classification database 143 for comparison purposes. The details of the ACM 113, ACM 141, and the classification database 143 are further described below.

In some embodiments, the functionalities of the ACM 113 and ACM 141 may be configured as a client partition and a server partition that can communicate between each other through the mobile network 120. For example, the ACM 113 may rely on the ACM 141 to perform some of the classification operations, or to access the classification database 143. Alternatively, the ACM 113 or the ACM 141 may act independently of each other to perform the classification operations. For example, the ACM 113 may access the classification database 143 without relying on the ACM 141.

In some embodiments, the classification assignment module 114 may be configured to receive user classifications obtained at a mobile device 110, and transmit the user classifications to the classification collection module 142 on the ACS 140 for further processing. For example, a user of the mobile device 110 may use a mobile application 112 running on the mobile device 110. Based on the experience of using the mobile application 112, the user may assign a classification for the mobile application 112. Afterward, the assigned classification may be inputted to the classification assignment module 114. The classification assignment module 114 may further interact with the ACM 113 to obtain additional information related to the mobile application 112 and transmit the obtained additional information along with the assigned classification to the classification collection module 142. The details of the classification assignment module 114 and the classification collection module 142 are further described below.

In one implementation, the computing processors 144 in the ACS 140 may be configured to execute programmable instructions to support the general operations of the ACS 140 and also the specific operations of the ACM 141. The computing processor 144 may utilize the memory 145 to store the data transmitted to or received from the mobile network 120. Similar processors and memory may be implemented in the mobile device 110 as well. Additional components, such as network communication adapters (e.g., Ethernet adapter, wireless adapter, Fiber Channel adapter, or GSM wireless module) may also be implemented in the mobile device 110 and the ACS 140.

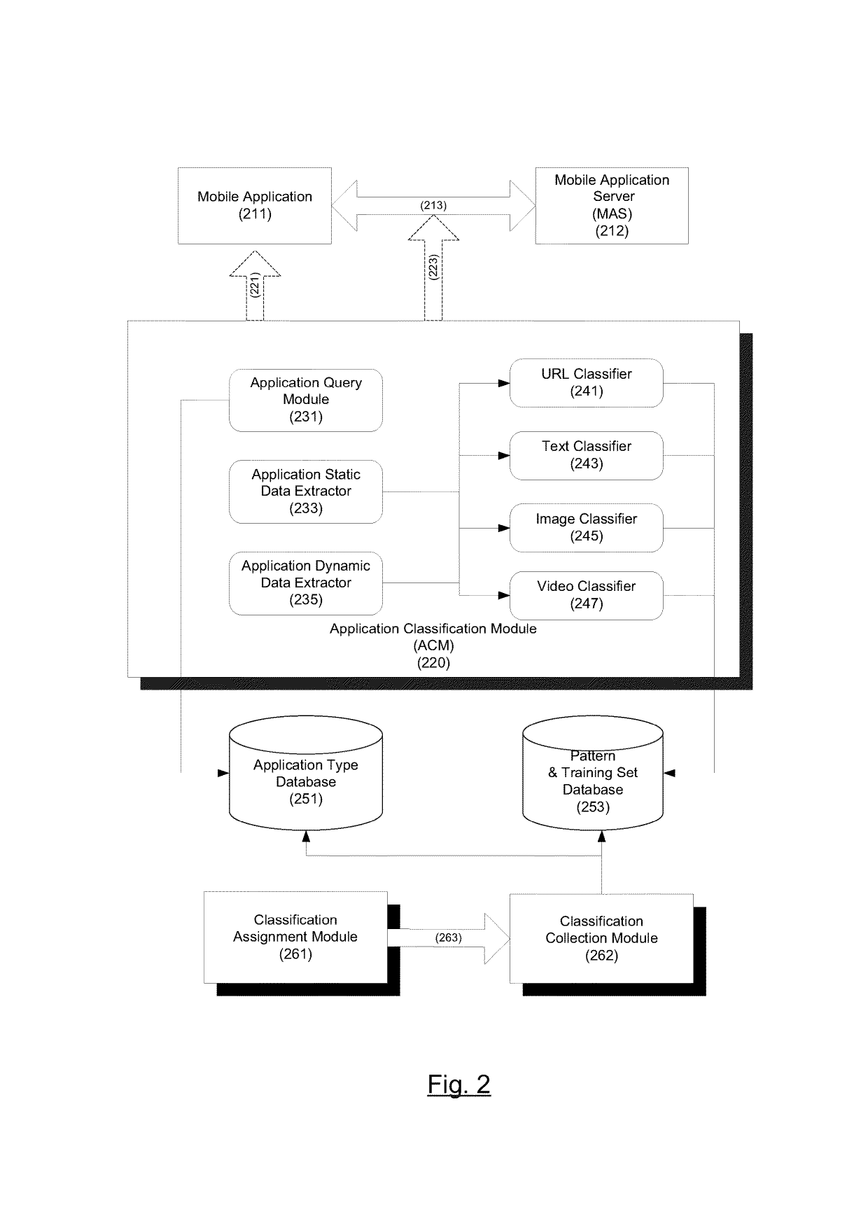

FIG. 2 illustrates scenarios of classifying a mobile application on a mobile device, in accordance with at least some embodiments of the present disclosure. In FIG. 2, a mobile application 211 (similar to the mobile application 112 of FIG. 1), may be configured to run on a mobile device (not shown in FIG. 2) and communicate with a mobile application server 212 (“MAS 212”, similar to the MAS 150 of FIG. 1). An application classification module 220 (“ACM 220”, similar to the ACM 112 or ACM 131 of FIG. 1), which may be installed on the mobile device or an application classification server (not shown in FIG. 2, but similar to the ACS 140 of FIG. 1), may be configured to statically or dynamically classify the mobile applications 211. The ACM 220 may utilize an application type database 251 and a patent and training set database 253, both of which may belong to the classification database 143 of FIG. 1. A classification assignment module 261 (similar to the classification assignment module 114 of FIG. 1) may be configured to interact with a classification collection module 263 (similar to the classification collection module 142 of FIG. 1), which may be configured to adaptively update the application type database 251 and the patent and training set database 253.

In some embodiments, the ACM 220 may contain, among other components, an application query module 231, an application static data extractor 233, and an application dynamic data extractor 235. The ACM 220 may further include multiple classifiers such as a URL classifier 241, a text classifier 243, an image classifier 245, and a video classifier 247. Once invoked, the ACM 220 may act as a background process and continuously detect and monitor the mobile application 211 operating on the mobile device. The mobile application 211 and the MAS 212 may or may not be aware of the presence of the ACM 220

In some embodiments, the application query module 231 may determine the type of the mobile application 211, running or not, by application name. The application query module 231 may browse the file directories of the mobile device, or query the mobile OS of the mobile device, to discover the application name of the installed or running mobile application 211. By comparing the discovered application name with the known ones in the application type database 251, the application query module 231 may be able to determine not only the type of the mobile application 211 and the kind of application data it contains, but also an understanding of how the mobile application 211 utilizes the application data.

In some embodiments, the application query module 231 may also determine the type of the mobile application 211 based on the mobile application 211′s operations and behaviors. For example, the application query module 231 may monitor the mobile application 211′s storage usage pattern. If the mobile application 211 is detected accessing a media file folder (e.g., DCIM), the application query module 231 may predict that the mobile application 211 is an image-related application for capturing, displaying, or processing images. The application query module 231 may also determine the type of mobile application 211 based on the network usage pattern associated with the mobile application 211. For example, a video streaming mobile application 211 may have a network usage pattern indicative of a significant amount of streaming data being downloaded from the mobile network. An email related mobile application may utilize specific protocols, such as SMTP/POP3/IMAP4, or access certain target network addresses such as Gmail® or Hotmail® sites.

In some embodiments, the types of mobile application 211 that may be monitored by the application query module 231 include, without limitation, VoIP (e.g., Skype®), audio/video streaming, MMS, web-conferencing, video uploading, email reception, email attachment transmitting and/or receiving, music download/upload, online gaming, and web browsing. Upon a determination of the type of the mobile application 211, the ACM 220 may be able to select the appropriate data extractors and classifiers for classifying the mobile application 211. Alternatively, if the type of the mobile application 211 is known and has been previously classified, then the ACM 220 may retrieve the previous classification associated with the known type of the mobile application 211, and assign the previous classification to the mobile application 211.

In some embodiments, the ACM 220 may utilize the application static data extractor 233 (“static data extractor 233”) to evaluate (221) the mobile application 211. If the mobile application 211 is downloaded but not installed, the static data extractor 233 may process the application package that contains the mobile application 211. For an installed mobile application 211, the static data extractor 233 may process the application files that are installed on the mobile device. Further, the ACM 220 may simultaneously evaluate 221 when the application package is being downloaded from the mobile network, or when the mobile application 211 is being extracted from the application package. In other words, the ACM 220 may continuously monitor the downloading and installation processes, and extract application data from the processes along with these processes.

In some embodiments, the static data extractor 233 may scan the installation files and temporary files associated with the mobile application 211 in order to extract a set of embedded data. For example, the static data extractor 233 may perform pattern matching to detect the presence of ASCII characters. Based on these characters, the static data extractor 233 may further determine whether the application data contains URL strings, text, images, and/or videos. Based on such a determination, the static data extractor 233 may perform additional processing to extract the embedded data (being URL string, text, image, or video) from the mobile application 211.

In some embodiments, the ACM 220 may choose the application dynamic data extractor 235 (“dynamic data extractor 235”) to evaluate the mobile application 211 that is executing on the mobile device. The dynamic data extractor 235 may monitor the actions performed by the mobile application 211 during its normal operations. For example, the dynamic data extractor 235 may peek into the storage spaces that are used by the mobile application 211 to save storage data. The dynamic data extractor 235 may also monitor the graphic user interface (GUI) of the mobile application 211, and capture snapshots of the GUI when the mobile application 211 is in operation. Further, the dynamic data extractor 235 may intercept (223) network data that are transmitted (213) by the mobile application 211 via the mobile network. The storage data and the network data may then be deemed application data for the mobile application 211, and a set of embedded data may be extracted from the application data, similar to the static data extractor 233 extracting the embedded data. The details of the dynamic data extractor 235 are further described below.

In some embodiments, the ACM 220 may classify the embedded data based on the data type previously determined. For example, when the embedded data is a URL string, the ACM 220 may select the URL classifier 241 to process the embedded data. Specifically, the pattern and training set database 253 may contain pairings of known URL strings and the corresponding classifications. The URL classifier 241 may compare the URL string with the known URL strings stored in the pattern and training set database 253. If a match is found, then the URL classifier 241 may select the classification corresponding to the matched URL string, and assign the same classification to the embedded data.

In some embodiments, the embedded data may be a text string. In this case, the ACM 220 may select the text classifier 243 for evaluation. Specifically, the pattern and training set database 253 may contain different examples of keywords that have sexual, violence, and other mature contents, with their associated classifications. Suppose the different classifications may correspond to severity levels ranging from lowest (e.g., general public) to highest (e.g., NC-17), then if a first keyword that has a specific severity level is found in the text string of the embedded data, then the embedded data may be classified with the classification associated with the first keyword. If a second keyword that has a higher severity level than the first keyword is found in the text string, then the classification for the embedded data may be increase to the value associated with the second keyword. Still, finding of the keywords with a lower severity level in the text string may not affect the classification of the embedded data.

In some embodiments, besides keyword matching, the pattern and training set database 253 may support other approaches to classify contents that may be considered to have sexual, violent, and/or other mature subject matters. Then text classifier 243 may utilize the natural language processing techniques and find out the optimal matched category for the text string of the embedded data using classification algorithms such as, without limitation, the Bayesain network. For example, certain text strings, which may have ordinary or benign meanings, but may also contain sexual innuendos when use in certain context. Thus, the Bayesian network approach may be used to detect the highly possible secondary meanings by evaluating not only the text strings by themselves, but also when combined with their neighboring text strings.

In some embodiments, the embedded data may be an image. In this case, the ACM 220 may select the image classifier 245 for classification purposes. In particular, the image classifier 245 may perform image pattern recognition on the image. Upon a finding of an obscene component (e.g., nudity, bloody scene, and others), the image classifier 245 may select an appropriate classification for the embedded data which such component and classification mapping is defined in pattern and training set database 253. Alternatively, the image classifier 245 may utilize an image processing algorithm to generate a set of features associated with the image from the image characteristics, such as color, histogram, shape, borders, etc. The image classifier 245 may utilize the training set contained in the pattern and training set database 253, and can apply the proper classification or grouping algorithm to determine the appropriate classification for the embedded data.

In some embodiments, the embedded data may be a video. In this scenario, the ACM 220 may select the video classifier 247 to perform the classification operations. The video classifier 247 may extract multiple frames from the video, and treat each of the extracted frames as an image. Afterward, the video classifier 247 may perform operations similar to the image classifier 245, and process the extracted frames one by one to generate a classification value for the embedded data.

In some embodiments, the embedded data may contain more than one type of data. For example, a gaming mobile application may contain URL string, text, image and video types of embedded data. In this case, the ACM 220 may extract each of these types of embedded data, and assign the corresponding classifier for classification. Afterward, the various classification values may then be evaluated, and the one with the highest severity level may be deemed the classification for the entire mobile application 211.

In some embodiments, the classification assignment module 261 may receive a user defined classification of a mobile application running on a mobile device. The user may subjectively determine a specific classification for the mobile application based on his or her usage experience. For example, the user may play a gaming mobile application and observe the contents of the gaming mobile application. Based on his/her past experience, the user may assign a specific classification (e.g., “Restricted”) to the gaming mobile application and invoke the classification assignment module 261 to input this specific classification. The user may optionally provide the name and type of the gaming mobile application to the classification assignment module 261. Further, the user may extract embedded application data (e.g., by capture a screen shot) from the mobile application and submit the embedded application data to the classification assignment module 261 as well.

In some embodiments, the classification assignment module 261 may transmit (263) the received mobile application name and type, embedded application data, and/or the user-assigned classification to the classification collection module 262. The classification collection module 262 may also collect the above various data from the classification assignment modules 261 that are located at different mobile devices. The classification collection module 262 may then process the various data. For example, the application name and type may be saved to the application type database 251. The embedded application data and the classifications may be stored in the pattern and training set database 253.

In some embodiments, for a specific mobile application, the classification collection module 262 may process the multiple user-assigned classifications received from different mobile devices and determine a “public” classification for the mobile application based on a predetermined threshold. The public classification may be deemed an objective, official classification for the mobile application. For example, the classification collection module 262 may determine an average, mean, or majority classification value from the received user-assigned classifications, and choose this determined classification value as “the” classification for the mobile application. Alternatively, the classification collection module 262 may perform its own classification process, and use the user-assigned classifications for verification and adjustment purposes. Afterward, the user-assigned classifications, and/or the public classification may be stored in the pattern and training set database 253.

In some embodiments, the classification collection module 262 may process the embedded application data either extracted by the ACM 220 or received from the classification assignment module 261, in order to adaptively update the pattern and training set database 253. The embedded application data may contain a specific URL, text, image, or video data that has already been assigned with a specific classification. The classification collection module 262 may then extract specific patterns and features from the embedded application data and save the extracted patterns and features to the pattern and training set database 253. Further, the classification collection module 262 may associate the patterns and features with the assigned classification in the pattern and training set database 253. Afterward, the pattern and training set database 253 may be adaptively adjusted for classifying additional application data.

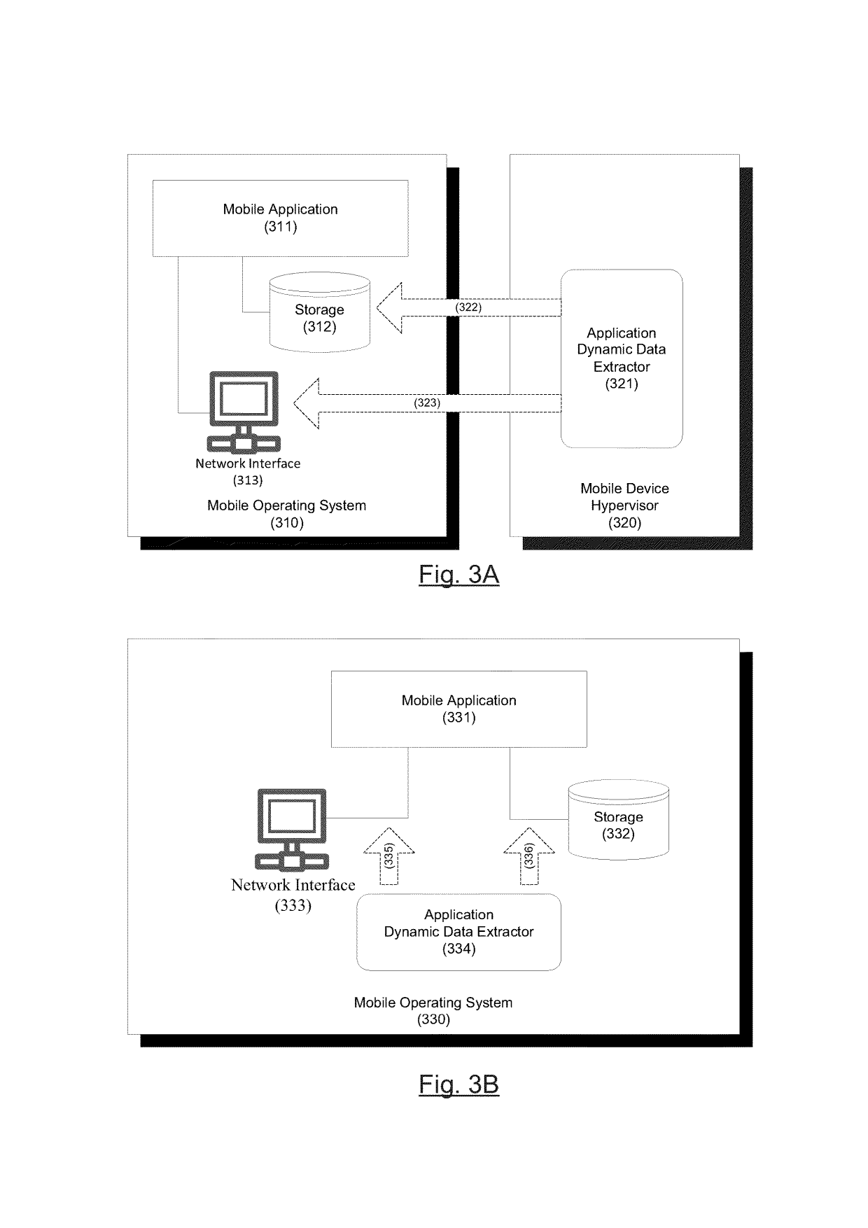

FIG. 3A and FIG. 3B illustrate multiple scenarios of dynamically extracting data from a mobile application on a mobile device, in accordance with at least some embodiments of the present disclosure. In FIG. 3A, a mobile application 311 (similar to the mobile application 112 of FIG. 1), may be configured to operate based on a mobile operating system 310 (“mobile OS 310”, similar to the mobile OS 111 of FIG. 1). The mobile application 311 may access storage 312 and the network interface 313 during its normal operations. A mobile device hypervisor 320 may provide a virtual environment for the mobile OS 310, as well as the mobile application 311. The mobile device hypervisor 320 may contain an application dynamic data extractor 321 (“dynamic data extractor 321”, similar to the dynamic data extractor 235 of FIG. 2).

In some embodiments, the mobile device hypervisor 320 may be a virtual machine that provides a hardware visualization environment for the mobile application 311. The mobile OS 310 may then be operative based on the mobile device hypervisor 320. In other words, the mobile OS 310 and the mobile application 311 may not be located on a mobile device, and may perform their operations as if being installed on a mobile device. Thus, the storage 312 and the network interface 313 may be provided to by the mobile device hypervisor 320 as well. Additional system components, such as a display, may also be provided by the mobile device hypervisor 320.

In some embodiments, the dynamic data extractor 321 may monitor and storage 312 and the network interface 313 when the mobile application 311 is operating. For example, during run time, when the mobile application 311 downloads media data from the mobile network and stores the downloaded data in the storage 312, the dynamic data extractor 321 may immediately get access (322) to the downloaded data from the storage 312, determine the types of the embedded data in the downloaded data, and classify the embedded data as described above. Similarly, when the mobile application 311 utilizes the network interface 313, the dynamic data extractor 321 may intercept (323) the packets being transmitted via the network interface 313, and extract embedded data from the packets. Further, the dynamic data extractor 321 may take snapshots of the mobile application 311's GUI display, and classify the images shown on the GUI display.

In FIG. 3B, a mobile operating system 331 (similar to the mobile application 112 of FIG. 1), may be configured to operate based on a mobile operating system 330 (“mobile OS 330”, similar to the mobile OS 111 of FIG. 1). The mobile application 331 may access storage 332 and the network interface 333 during its normal operations. An application dynamic data extractor 334 (“dynamic data extractor 334”, similar to the dynamic data extractor 235 of FIG. 2) may also be configured to operate based on the mobile OS 330.

In some embodiments, the dynamic data extractor 334 may have a better knowledge of the mobile application 331, and may act as a background process to monitor and record the application data processed by the mobile application 331. For example, the dynamic data extractor 334 may be aware of the specific files the mobile applications 331 is accessing in the storage 332, and may constantly pulling (336) the application data from the specific files. Likewise, the dynamic data extractor 334 may capture the GUI display as the application data for the mobile application 331 through the functionalities provided by the mobile OS 330.

In some embodiments, the dynamic data extractor 334 may listen (335) to the ports of the network interface 333 that is accessed by the mobile application 331. For example, the listening may indicate that the mobile application 331 is sending application data through the network interface 333. The dynamic data extractor 334 may then intercept the sending packets, and extract application data from therein. Likewise, the dynamic data extractor 334 may detect a network usage pattern showing that the mobile application 331 is receiving/downloading application data. The dynamic data extractor 334 may then intercept the receiving packets, and process these packets to extract application data.

In some embodiments, the above two scenarios allow the dynamic data extractor 334 to monitor and classify the mobile application 331, as well as the application data utilized by the mobile application 331, during run time. Such an approach may ensure that even when the mobile application 331 passes a certain classification, its application data may still need to be classified in order to be processed on the mobile device.

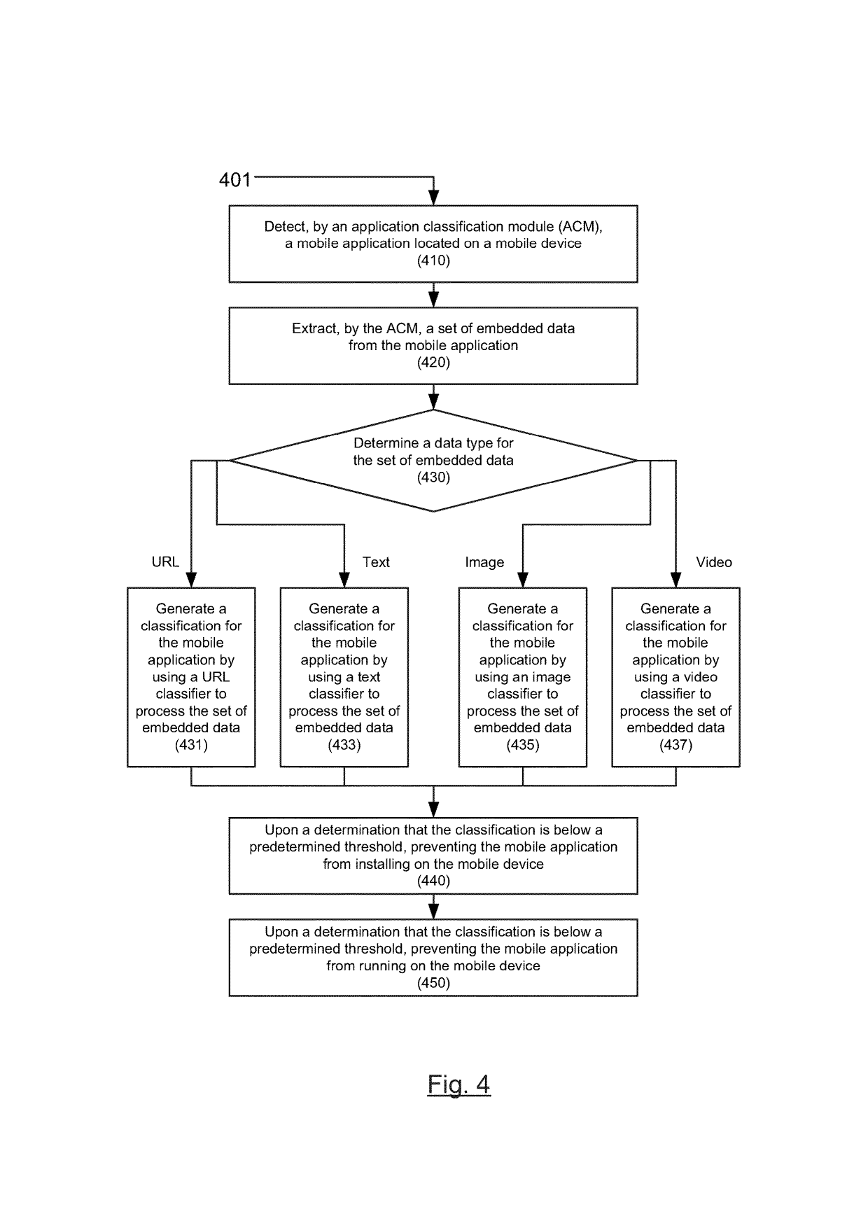

FIG. 4 illustrates a flow diagram of an example process 401 for classifying a mobile application running on a mobile device, in accordance with at least some embodiments of the present disclosure. The process 401 may be performed by processing logic that may comprise hardware (e.g., special-purpose circuitry, dedicated hardware logic, programmable hardware logic, etc.), software (such as instructions that may be executed on a processing device), firmware or a combination thereof. In one embodiment, machine-executable instructions for the process 401 may be stored in memory 145 of FIG. 1, executed by the processor 144 of FIG. 1, and/or implemented in an ACM 113 or an ACM 141 of FIG. 1.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

At block 410, an ACM may detect a mobile application located on a mobile device. The mobile application may be downloaded from an application store, and may yet to be installed on the mobile device. Alternatively, the mobile application may be installed or running on the mobile device. In one embodiment, the mobile application may be uploaded to a mobile application server, and the ACM is located on an application classification server for classifying the mobile application. The ACM may utilize an application query module to detect the presence of the mobile application.

At block 420, the ACM may extract a set of embedded data from the mobile application. In some embodiments, the ACM may use a static data extractor to extract the set of embedded data from a static and non-executing mobile application. Alternatively, the ACM may use a dynamic data extractor to extract the set of embedded data from the executing mobile application.

At block 430, the application query module of the ACM may determine a data type for the set of embedded data. If the determination at block 430 is “URL” type, then process 401 may proceed to block 431. For “text”, “image”, or “video” type, the process 401 may proceed to block 433, block 435, or block 437 respectively.

At block 431, the ACM may select a URL classifier to process the set of embedded data in order to generate a classification for the mobile application. Likewise, at block 433, the ACM may select a text classifier to process the set of embedded data that contains text strings. At block 435, the ACM may choose an image classifier to process the set of embedded data. And at block 437, the ACM may select a video classifier to process the set of embedded data.

In some embodiments, the set of embedded data may contain multiple data types. In this case, the ACM may simultaneously transmit different types of the embedded data to their corresponding classifiers. After receiving multiple classification values from these classifiers, the ACM may select the one classification that has the highest severity level among the received classification values, and assign this classification as the classification for the mobile application.

At block 440, the ACM may determine whether the classification meets the classification requirement defined by the user. Upon a determination that the classification is below a predetermined threshold (i.e., the classification is has a severity level that is higher than the predetermined threshold), the ACM may prevent the mobile application from being installed on the mobile device. If the mobile application is already installed, the ACM may optionally remove such mobile application from the mobile device. For example, upon a determination that a particular gaming mobile application has a “NC-17” like rating that is below a predetermined threshold of “Restricted”, then mobile application may not be allowed to exist on the mobile device.

At block 450, the ACM may make a similar classification evaluation as at block 440. Upon a determination that the classification is below the predetermined threshold, the ACM may prevent the mobile application from executing on the mobile device.

In some embodiments, the ACM and the mobile application may be located on the same mobile device. The ACM may then classify the mobile application either independently, or utilize the classification databases that are located remotely on an application classification server. Alternatively, a second ACM may be located on the application classification server to interact with the first ACM that is located on the mobile device. In this case, the first ACM may transmit the embedded data to the remote application classification server, so that the second ACM may perform its classification operations. Afterward, the generated classification may then be transmitted back to the mobile device, and be evaluated by the first ACM accordingly.

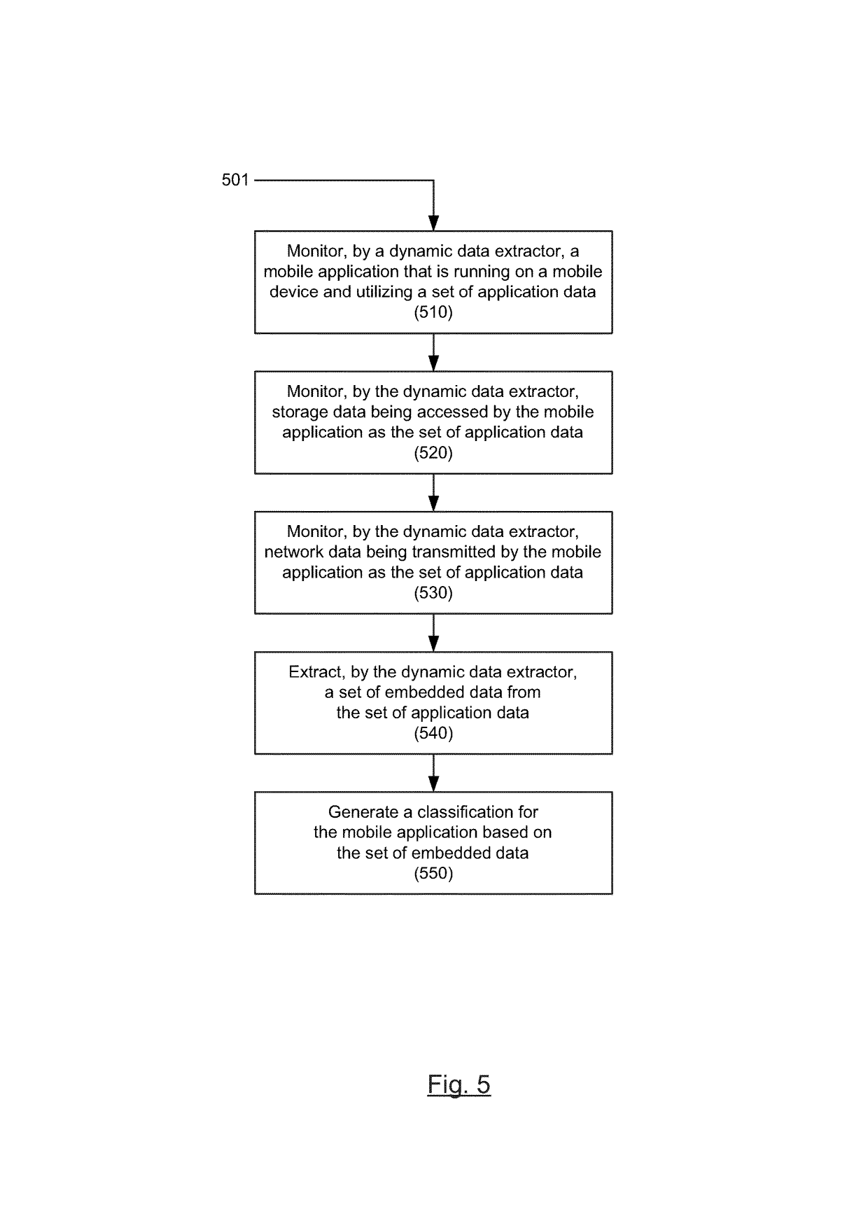

FIG. 5 illustrates a flow diagram of an example process 501 for dynamically extracting embedded data from a running mobile application, in accordance with at least some embodiments of the present disclosure. The process 501 may be performed by processing logic that may comprise hardware (e.g., special-purpose circuitry, dedicated hardware logic, programmable hardware logic, etc.), software (such as instructions that may be executed on a processing device), firmware or a combination thereof. In one embodiment, machine-executable instructions for the process 501 may be stored in memory, executed by a processor, and/or implemented in a mobile device 110 of FIG. 1.

At block 510, a dynamic data extractor of an ACM may monitor a mobile application running on a mobile device. In one embodiment, the dynamic data extractor may be located in a mobile device hypervisor that is acting as the mobile device. Alternatively, the dynamic data extractor may be running on the mobile device, similar to the mobile application. During execution, the mobile application may be utilizing a set of application data.

At block 520, the dynamic data extractor may monitor the storage data that is being accessed by the mobile application. In this case, the storage data may be deemed the set of application data. In some embodiments, the dynamic data extractor may have access to the storage that is provided by the mobile device hypervisor. The dynamic data extractor may also pull the storage for the application data.

At block 530, the dynamic data extractor may monitor the network data that is being transmitted by the mobile application. In this case, the network data may be deemed the set of application data. In some embodiments, the dynamic data extractor may have access to the network interface that is provided by the mobile device hypervisor. Alternatively, the dynamic data extractor may listen to the ports of the network interface utilized by the mobile application.

At block 540, the dynamic data extractor may extract a set of embedded data from the application data. At block 550, the ACM may process the set of embedded data and generate a classification for the mobile application, similar to the approaches described above.

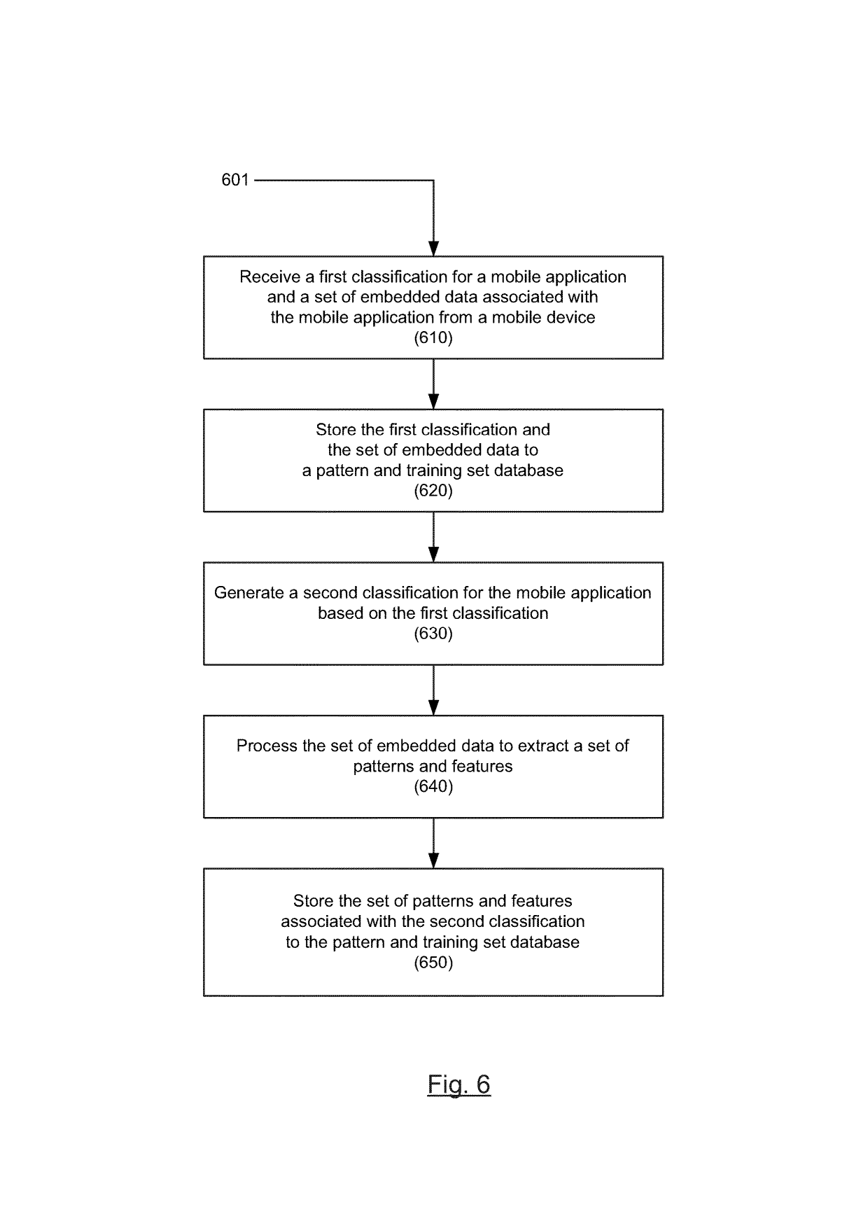

FIG. 6 illustrates a flow diagram of an example process 601 for adaptively adjusting a general classification for a mobile application based on a specific classification, in accordance with at least some embodiments of the present disclosure. The process 601 may be performed by processing logic that may comprise hardware (e.g., special-purpose circuitry, dedicated hardware logic, programmable hardware logic, etc.), software (such as instructions that may be executed on a processing device), firmware or a combination thereof. In one embodiment, machine-executable instructions for the process 601 may be stored in memory, executed by a processor, and/or implemented in a mobile device 110 of FIG. 1.

At block 610, a classification assignment module running on a mobile device may obtain a first classification and a set of embedded data for a mobile application running on the mobile device. The first classification may be a user-assigned classification provided by a user of the mobile application. The set of embedded data may be identified and provided by the user of the mobile application, or extracted by an application classification module running on the mobile device. The application static data extractor of the application classification module may extract the set of embedded data from the mobile application's installation package or installation files, or the application dynamic data extractor of the application classification module may extract the set of embedded data when the mobile application is dynamically performing storage or network operations. The classification assignment module may also obtain the mobile application's name and type provided by the user or determined by the application classification module.

In some embodiments, the user of the mobile application on the mobile device may identify the set of embedded data for the mobile application, and assign the first classification to the set of embedded data as well as the mobile application. For example, when viewing an image being displayed on the mobile application, the user may subjectively identify the name and type of the mobile application, assign a classification value (e.g., “restricted”) to the image, and transmit the mobile application name and type, the image, and the classification value to the classification assignment module. Afterward, a classification collection module running on an application classification server may obtain the first classification, the set of embedded data, and/or the mobile application's name and type from the classification assignment module.

At block 620, the classification collection module may store the first classification and the set of embedded data to a pattern and training set database. That is, the set of embedded data may be categorized and properly stored in the pattern and training set database. The set of embedded data and the first classification may optionally be associated with the mobile application. At block 630, the classification collection module may generate a second classification for the mobile application based on the first classification and the pattern and training set database. In other words, the classification collection module may determine a general public classification for the mobile application based on one or more user-assigned classifications obtained from multiple mobile devices running the mobile application.

At block 640, the classification collection module may process the set of embedded data to extract a set of patterns and features. The set of patterns and features may be used for training the application classification module for classifying similar data. At block 650, the set of patterns and features may be stored to the pattern and training set database, and be associated with the second classification for the mobile application in the pattern and training set database.

Thus, methods and systems for classifying mobile applications have been described. The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or firmware to implement the techniques introduced here may be stored on a non-transitory machine-readable storage medium and may be executed by one or more general-purpose or special-purpose programmable microprocessors. A “machine-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). For example, a machine-accessible storage medium includes non-transitory recordable/non-recordable media (e.g., read-only memory (ROM), random access memory (RAM), magnetic disk storage media, optical storage media, flash memory devices, etc.)

Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense.

I claim:

1. A method for classifying a mobile application, comprising:
detecting, by an application classification module, a mobile application located on a mobile device;
extracting, by the application classification module, a set of embedded data from the mobile application; and
obtaining, by the application classification module, a classification for the mobile application by analyzing the set of embedded data using a pattern and training set database.

2. The method as recited in claim 1, further comprising:
upon a determination that the classification is below a predetermined threshold, preventing the mobile application from installing or executing on the mobile device.

3. The method as recited in claim 1, wherein the obtaining the classification comprises:
identifying, by the application classification module running on the mobile device, a data type for the set of embedded data; and
generating the classification by invoking a classifier corresponding to the data type for analyzing the set of embedded data.

4. The method as recited in claim 3, wherein a URL classifier generates the classification by comparing a URL extracted from the set of embedded data with URLs stored in the pattern and training set database.

5. The method as recited in claim 3, wherein a text classifier generates the classification by comparing a text string extracted from the set of embedded data with the pattern and training set database.

6. The method as recited in claim 3, wherein a graphic classifier generates the classification by comparing an image extracted from the set of embedded data with the pattern and training set database.

7. The method as recited in claim 3, wherein a video classifier generates the classification by comparing a video extracted from the set of embedded data with the pattern and training set database.

8. The method as recited in claim 1, wherein the obtaining the classification comprises:
transmitting, by the application classification module, the set of embedded data to a remote classification server via a mobile network; and
receiving, from the remote classification server, the classification for the mobile application.

9. The method as recited in claim 1, wherein the extracting the set of embedded data comprises:
monitoring, by a dynamic data extractor, the mobile application utilizing a set of application data; and
extracting, by the dynamic data extractor, the set of embedded data from the set of application data.

10. The method as recited in claim 9, wherein the monitoring the mobile application comprises:
monitoring storage data being accessed by the mobile application as the set of application data.

11. The method as recited in claim 9, wherein the monitoring the mobile application comprises:
intercepting network data being transmitted by the mobile application as the set of application data.

12. The method as recited in claim 9, wherein the dynamic data extractor is executing on the mobile device while monitoring the mobile application accessing the set of application data via a storage on the mobile device, and monitoring the mobile application transmitting the set of application data via a network interface on the mobile device.

13. The method as recited in claim 9, wherein the dynamic data extractor is executing on a mobile device hypervisor and has access to a storage on the mobile device that is utilized by the mobile application for storing the set of application data, and access to a network interface on the mobile device that is utilized by the mobile application for transmitting the set of application data.

14. A method for classifying a mobile application running on a mobile device, comprising:
obtaining, by a classification collection module, a first classification for the mobile application and a set of embedded data extracted from the mobile application;
processing, by the classification collection module, the set of embedded data to extract a set of patterns and features; and
storing, by the classification collection module, the set of patterns and features to a pattern and training set database, wherein the pattern and training set database is used by an application classification module to classify the mobile application.

15. The method as recited in claim 14, further comprising:
generating a second classification for the mobile application based on the first classification and the pattern and training set database.

16. The method as recited in claim 14, further comprising:
associating the second classification with the set of patterns and features in the pattern and training set database.

17. A system configured to classify a mobile application running on a mobile device, comprising:
a data extractor for monitoring the mobile application and extracting a set of embedded data from the mobile application; and
a classifier coupled with the data extractor for receiving the set of embedded data from the data extractor, and generating a classification for the mobile application based on the set of embedded data.

18. The system as recited in claim 17 wherein the classifier is a URL classifier, a text classifier, a graphic classifier, or a video classifier.

19. The system as recited in claim 17, wherein the data extractor extracts the set of embedded data by statically evaluating the mobile application's installation files.

20. The system as recited in claim 17, wherein the data extractor extracts the set of embedded data by dynamically evaluating the mobile application being executed on the mobile device.
